(19) United States
(12) Patent Application Publication
(10) Pub. No.: US 2016/0140703 A1
(43) Pub. Date: May 19, 2016

(54) SYSTEM FOR INSPECTING VEHICLE BODY AND METHOD THEREOF

(71) Applicant: Hyundai Motor Company, Seoul (KR)

(72) Inventor: Tae Ho Kim, Seoul (KR)

(21) Appl. No.: 14/745,702

(22) Filed: Jun. 22, 2015

(30) Foreign Application Priority Data
Nov. 17, 2014 (KR) 10-2014-0160329

(51) Int. Cl. G06T 7/00; G07C 5/12; H04N 5/225; G07C 5/08

(52) U.S. Cl. CPC G06T 7/001; G07C 5/0808; G07C 5/12; H04N 5/225; G06T 2207/30248

(57) ABSTRACT

A system for inspecting a vehicle body includes: an image processing unit photographing at least one pattern image projected onto a surface of the vehicle body, comparing the at least one photographed pattern image to a reference pattern image, and determining whether a defective portion is formed on the vehicle body based on the comparison of the at least one photographed pattern image to the reference pattern image; a moving unit moving the image processing unit in a length direction and a height direction of the vehicle body; and a motion control unit controlling movement of the moving unit.

### CROSS-REFERENCE TO RELATED APPLICATION

This application claims priority to and the benefit of Korean Patent Application No. 10-2014-0160329 filed in the Korean Intellectual Property Office on Nov. 17, 2014, the entire contents of which are incorporated herein by reference.

### BACKGROUND OF THE DISCLOSURE

(a) Technical Field

The present disclosure relates generally to a system and method for inspecting a vehicle body. More particularly, the present disclosure relates to a system and method for inspecting a vehicle body for accurate determination of a defect formed at a vehicle body by image processing.

(b) Description of the Related Art

In general, a vehicle body consists of multiple different panels, such as a roof, a hood, doors, a trunk lid, and the like, to form an exterior appearance of the vehicle body. During manufacture, it is necessary that the vehicle body has no defective portions, i.e., protrusions, depressions, bends, cracks, scratches, etc., formed thereon. To this end, conventionally, an exterior of the vehicle body has been inspected only with the naked eye of a worker. However, since inspection based on a worker's naked eye relies on the worker's own determination of quality, it can be difficult to make an accurate determination of the existence of defects on the vehicle body exterior. Therefore, reliability is poor and uniform quality management on the vehicle body is difficult.

The above information disclosed in this Background section is only for enhancement of understanding of the background of the disclosure and therefore it may contain information that does not form the related art that is already known in this country to a person of ordinary skill in the art.

### SUMMARY OF THE DISCLOSURE

An object of the present disclosure for solving above problems is to provide a system and method for inspecting a vehicle body which enables determination of defective portions of a vehicle body by an image processing technique.

According to embodiments of the present disclosure, a system for inspecting a vehicle body includes: an image processing unit photographing at least one pattern image projected onto a surface of the vehicle body, comparing the at least one photographed pattern image to a reference pattern image, and determining whether a defective portion is formed on the vehicle body based on the comparison of the at least one photographed pattern image to the reference pattern image; a moving unit moving the image processing unit in a length direction and a height direction of the vehicle body; and a motion control unit controlling movement of the moving unit.

The image processing unit may include: a pattern projecting unit projecting pattern images, each having a phase shifted by a predetermined space, onto the surface of the vehicle body in succession; a camera unit photographing the at least one pattern image of the projected pattern images; and an image control unit comparing the at least one pattern image photographed by the camera unit to the reference pattern image and determining whether the defective portion is formed on the vehicle body based on the comparison of the at least one pattern image photographed by the camera unit to the reference pattern image.

The pattern projecting unit may include a rotating mirror rotatably provided thereto, and a plurality of pattern generating units arranged at fixed spaces centered on the rotating mirror for generating the pattern images.

The pattern images generated by the plurality of pattern generating units may have phases shifted by predetermined spaces from one another, and the pattern images generated by the plurality of pattern generating units may be projected onto the vehicle body as the rotating mirror rotates.

The motion control unit may provide information about a moving speed and acceleration of the moving unit to the image processing unit, and the image processing unit may photograph the pattern images projected onto a surface of the vehicle body at equal spacing based on the information about the moving speed and acceleration.

Image photographing areas of the pattern images photographed by the image processing unit may be overlapped by predetermined spaces in the length direction and the height direction of the vehicle body.

The image processing unit may measure a position of the vehicle body from a reference hole formed in the vehicle body, and the motion control unit may correct movement of the moving unit according to the position of the vehicle body measured by the image processing unit.

The image processing unit may compare a predetermined reference position to a measured position of the reference hole and calculates a correction distance of the vehicle body based on the comparison of the predetermined reference position to the measured position of the reference hole.

Furthermore, according to embodiments of the present disclosure, a method for inspecting a vehicle body includes: projecting pattern images onto a surface of the vehicle body; photographing at least one pattern image of the pattern images projected onto the surface of vehicle body; comparing the at least one photographed pattern image to a reference pattern image; and determining whether a defective portion is formed on the vehicle body based on the comparison of the at least one photographed pattern image to the reference pattern image.

The pattern images may be projected onto the surface of the vehicle body in succession, each of the pattern images having phases shifted by predetermined spaces.

The determining of whether the defective portion is formed on the vehicle body may include comparing a phase and a cycle of the at least one photographed pattern image to a phase and a cycle of the reference pattern image.

The method may further include correcting an image photographing position based on a position of the vehicle body determined with reference to a vehicle body stop position.

The correcting of the image photographing position may include: photographing a reference hole formed in the vehicle body, comparing the photographed reference hole to the reference pattern image; calculating a correction distance of the vehicle body based on the comparison of the photographed reference hole to the reference pattern image, and setting an image photographing area of the vehicle body according to the calculated correction distance.

The method may further include transmitting, to an image processing unit which photographs the vehicle body, information about a moving speed and acceleration of a moving unit which moves the image processing unit.

The pattern images projected onto the vehicle body may be photographed at equal spacing based on the information about the moving speed and acceleration.

The image photographing areas of the photographed pattern images may be overlapped by predetermined spaces in a length direction and a height direction of the vehicle body.

The method may further include generating a warning when a defective portion is formed on the vehicle body.

Accordingly, the system for inspecting a vehicle body in accordance with embodiments of the present disclosure permits exact determination of the defective portion of the vehicle body by photographing an image of the vehicle body having a plurality of pattern images that are shifted by predetermined spaces projected onto a vehicle body surface. Further, when an image of the vehicle body surface is photographed, since the image of the vehicle body is photographed by taking the speed and the acceleration of the moving unit into account, the image of vehicle body may be photographed at equal spacing.

### BRIEF DESCRIPTION OF THE DRAWINGS

Since the drawings are provided as a reference for describing illustrative embodiments of the present disclosure, technical aspects of the present disclosure should not be interpreted as being limited to the accompanying drawings.

FIG. 1 illustrates a schematic view of a vehicle body inspection system in accordance with embodiments of the present disclosure.

FIG. 2 illustrates a block diagram of a vehicle body inspection system in accordance with embodiments of the present disclosure.

FIG. 3 illustrates a schematic view of an image processing unit in accordance with embodiments of the present disclosure.

FIG. 4 illustrates a schematic view of a pattern projecting unit in accordance with embodiments of the present disclosure.

FIG. 5 illustrates diagrams showing a pattern image projected on a vehicle body by a pattern projecting unit and a phase of the pattern image in accordance with embodiments of the present disclosure, respectively.

FIG. 6 illustrates diagrams showing a pattern image photographed by a camera unit and a phase of the pattern image in accordance with embodiments of the present disclosure, respectively.

FIG. 7 illustrates a graph showing a moving speed of a moving unit in accordance with embodiments of the present disclosure.

FIG. 8 illustrates a schematic view showing an image photographing area of a vehicle body in accordance with embodiments of the present disclosure.

FIG. 9 illustrates a schematic view showing a vehicle body position correcting method in accordance with embodiments of the present disclosure.

FIG. 10 illustrates a flowchart showing the steps of a method for inspecting a vehicle body in accordance with embodiments of the present disclosure.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

Parts not relevant to the present disclosure will be omitted for describing the present disclosure clearly, and throughout the specification, identical or similar parts will be given the same reference numbers. Further, since sizes and thicknesses of elements are shown at will for convenience of description, the present disclosure is not limited to the drawings, but the thicknesses are enlarged for clearly expressing different parts and regions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Referring now to the disclosed embodiments, a system for inspecting a vehicle body will now be described with reference to the attached drawings.

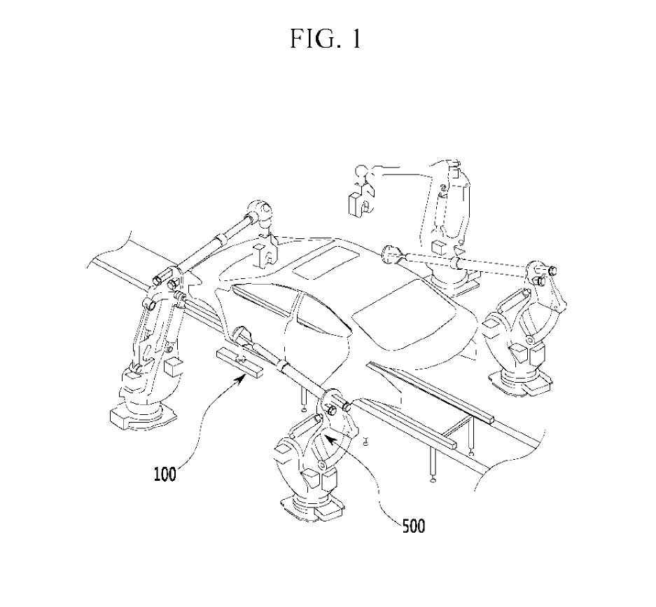

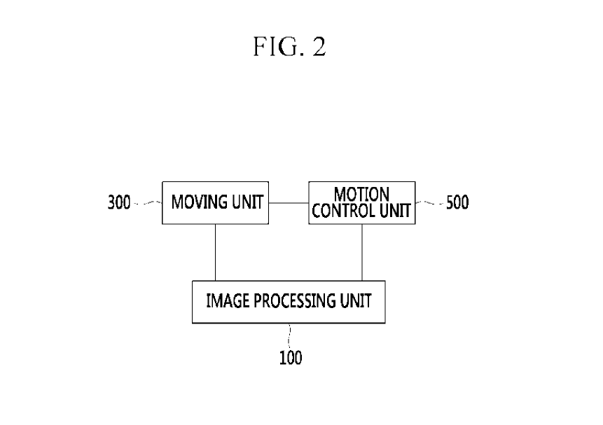

FIG. 1 illustrates a schematic view of a vehicle body inspection system in accordance with embodiments of the present disclosure. FIG. 2 illustrates a block diagram of a vehicle body inspection system in accordance with embodiments of the present disclosure.

As shown in FIGS. 1 and 2, the vehicle body inspection system in accordance with embodiments of the present disclosure includes an image processing unit 100, a moving unit 300, and a motion control unit 500.

The image processing unit 100 photographs an image of a pattern image projected onto a vehicle body surface for determining a defective portion of the vehicle body from the pattern image photographed thus and a reference pattern image.

The moving unit 300 has the image processing unit 100 provided thereto. The moving unit 300 may be a robot for moving the image processing unit 100 in a vehicle length direction and a vehicle height direction. The motion control unit 500 controls movement of the moving unit 300.

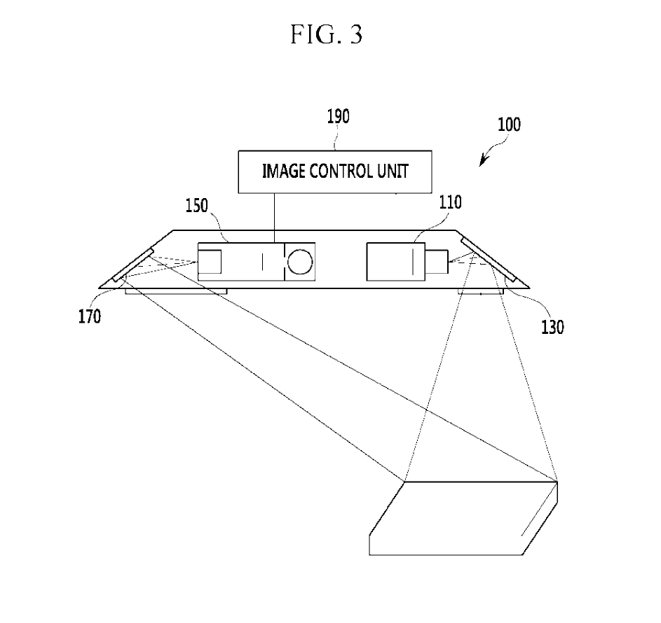

FIG. 3 illustrates a schematic view of an image processing unit in accordance with embodiments of the present disclosure.

As shown in FIG. 3, the image processing unit 100 includes a pattern projecting unit 110 for projecting a pattern image onto the vehicle body, a camera unit 150 for photographing an image of the pattern image projected onto the vehicle body by the pattern projecting unit 110, and an image control unit 190 for comparing the pattern image photographed by the camera unit 150 to a reference pattern image to determine a defective portion formed at the vehicle body.

The image control unit 190 may be at least one processor operated by a predetermined program, wherein the predetermined program is programmed to carry out the steps of a method for inspecting a vehicle body in accordance with a preferred embodiment of the present disclosure.

The pattern image projected from the pattern projecting unit 110 may be reflected at a first reflective mirror 130 to be directed onto the vehicle body. The pattern image projected onto the vehicle body may be reflected at a second reflective mirror 170 and photographed by the camera unit 150.

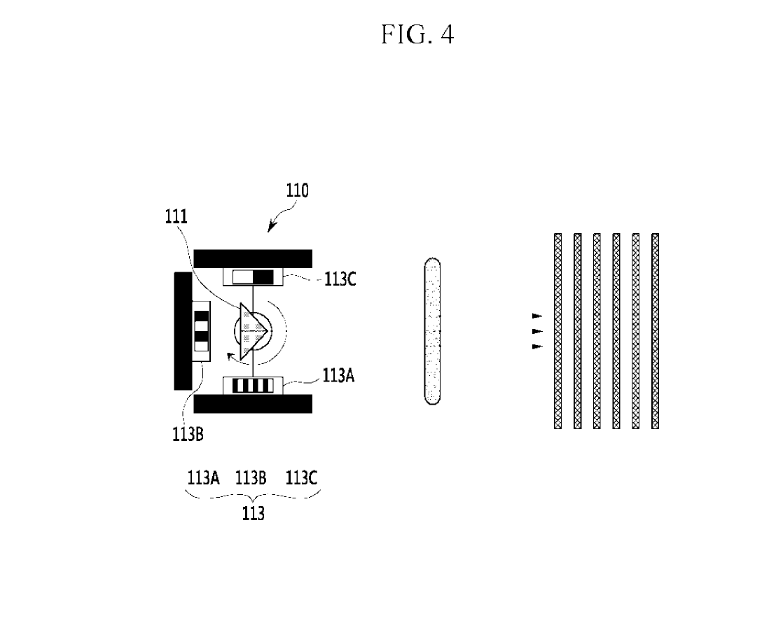

FIG. 4 illustrates a schematic view of a pattern projecting unit in accordance with embodiments of the present disclosure.

As shown in FIG. 4, the pattern projecting unit 110 includes a rotating mirror 111 rotatably provided thereto, and a plurality of pattern generating units 113 arranged at fixed spaces centered on the rotating mirror 111 for generating pattern images.

The pattern generating units 113 may be LEDs for emitting predetermined pattern images. Preferably, the pattern projecting unit 110 may have three pattern generating units 113, for example. However, the present disclosure is not limited to this, and the pattern projecting unit 110 may have more than three or less than three pattern generating units 113.

The pattern generating units 113 have a first pattern generating unit 113A, a second pattern generating unit 1138, and a third pattern generating unit 113C arranged at 90° spacing centered on the rotating mirror 111. The pattern images projected from the three pattern generating units 113A, 1138, and 113C have phases that are shifted by fixed spacing, respectively.

That is, the three pattern generating units 113 are fixedly secured to be centered on the rotating mirror 111, for projecting the pattern image generated at the first pattern generating unit 113A to the third pattern generating unit 113C to the vehicle body in succession as the rotating mirror 111 rotates.

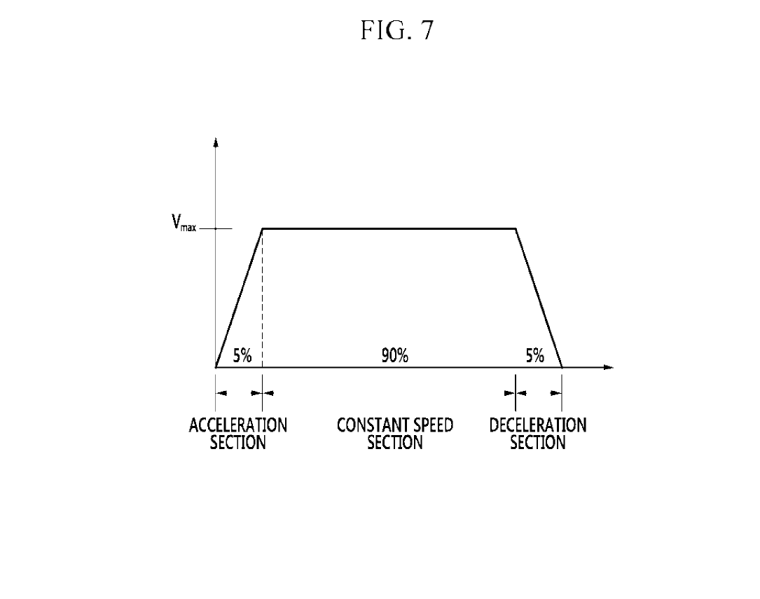

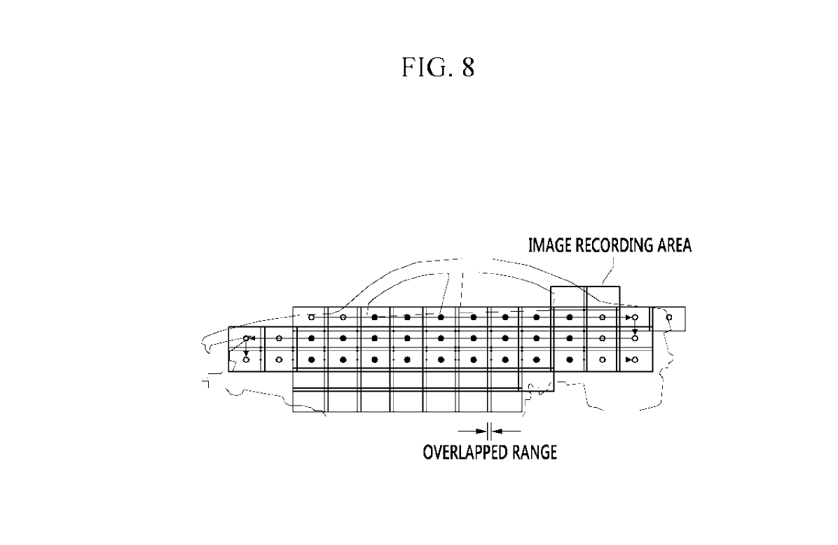

FIG. 7 illustrates a graph showing a moving speed of a moving unit 300 in accordance with embodiments of the present disclosure. FIG. 8 illustrates a schematic view showing an image photographing area of a vehicle body in accordance with embodiments of the present disclosure.

As shown in FIG. 8, if the motion control unit 500 moves the moving unit 300 having the image processing unit 100 provided thereto in a length direction of the vehicle body, the camera unit 150 of the image processing unit 100 photographs images of the vehicle body in units of the image photographing area. The image photographed by the camera unit 150 is provided to the image control unit 190.

In this case, the motion control unit 500 provides information on a moving speed and moving acceleration of the moving unit 300 to the image processing unit 100. The image processing unit 100 photographs images of the pattern image projected onto the vehicle body at equal spacing based on the information on the speed and the acceleration provided from the motion control unit 500.

That is, as shown in FIG. 7, upon examining the movement of the moving unit 300 moving in the length direction of the vehicle body, it may be known that 90% of entire movement is in a constant velocity section, 5% of the entire movement is in an acceleration section, and 5% of the entire movement is in a deceleration section. The acceleration/deceleration sections of the moving unit 300 are sections in which the moving unit 300 changes a direction. Therefore, the image processing unit 100 may photograph images of the image photographing area photographed by the camera unit 150 at the equal spacing based on the information on the acceleration section, the deceleration section, and the constant velocity section of the moving unit 300.

For example, if the moving unit 300 moves through the constant velocity section, the camera unit 150 photographs images of the vehicle body at the same time intervals. However, if the moving unit 300 is moving through the acceleration or the deceleration section, the camera unit 150 may photograph images of the image photographing areas of the vehicle body at the equal spacing by adjusting time intervals of photographing images of the vehicle body according to the acceleration or the deceleration compared to the constant velocity section.

It is preferable that the image photographing areas of the images photographed by the image processing unit 100 are overlapped by predetermined spaces in the length direction and the height direction of the vehicle body. Thus, by photographing images of the image photographing areas overlapped by the predetermined spaces, the defective portions of the vehicle body may be photographed without exception.

In the meantime, the image processing unit 100 measures a position of the vehicle body from a reference hole formed in the vehicle body. The motion control unit 500 corrects movement of the moving unit 300 according to the position of the vehicle body measured by the image processing unit 100. In the vehicle inspection process, it is not possible for the vehicle body to stop at an exact stop position. Therefore, in order to solve such a problem, the movement of the moving unit 300 is corrected according to the stop position of the vehicle body.

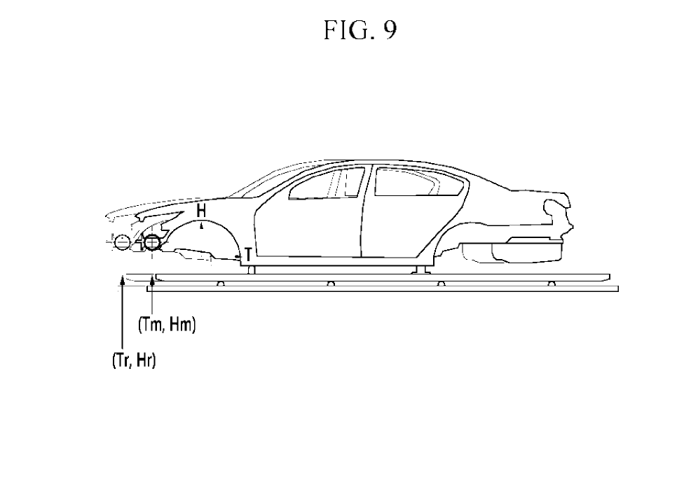

In detail, referring to FIG. 9, the camera unit 150 of the image processing unit 100 compares an image of the reference hole formed in the vehicle body to a reference coordinate image to calculate a correction distance of the vehicle body.

The reference pattern image has the reference hole coordinate values Tr, Hr when the vehicle body is stopped at the exact stop position stored therein. Reference hole coordinate values Tm, Hm of the image photographed by the camera unit 150 of the image processing unit 100 are compared to the coordinate values Tr, Hr of the reference coordinate image, to calculate the correction distance of the vehicle body. For example, if it is assumed that a difference of the reference hole coordinate values of the image photographed by the camera unit 150 and the coordinate values of the reference coordinate image are 10 cm in a T-direction (i.e., a length direction of the vehicle body), and 5 cm in an H-direction (i.e., a height direction of the vehicle body), the image processing unit 100 determines that the difference of the coordinate value of the image of the reference hole and the coordinate value of the reference coordinate image as the correction distance.

The motion control unit 500 controls movement of the moving unit 300 provided to the image processing unit 100 by using the correction distance to correct the image photographing position of the vehicle body. Thus, by correcting the image photographing position of the vehicle body according to the movement of the moving unit 300 controlled with reference to the correction distance measured according to the stop position of the vehicle body, the defective portions formed on entire portions of the vehicle body may be exactly determined.

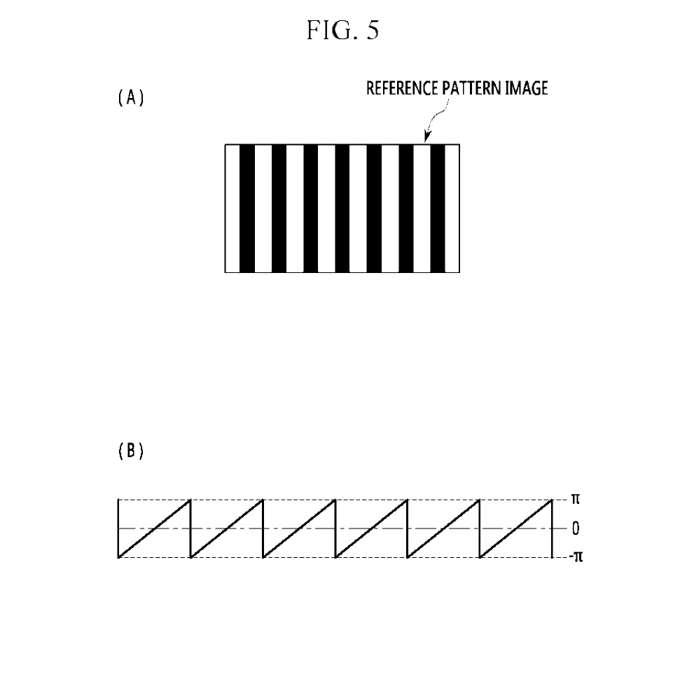

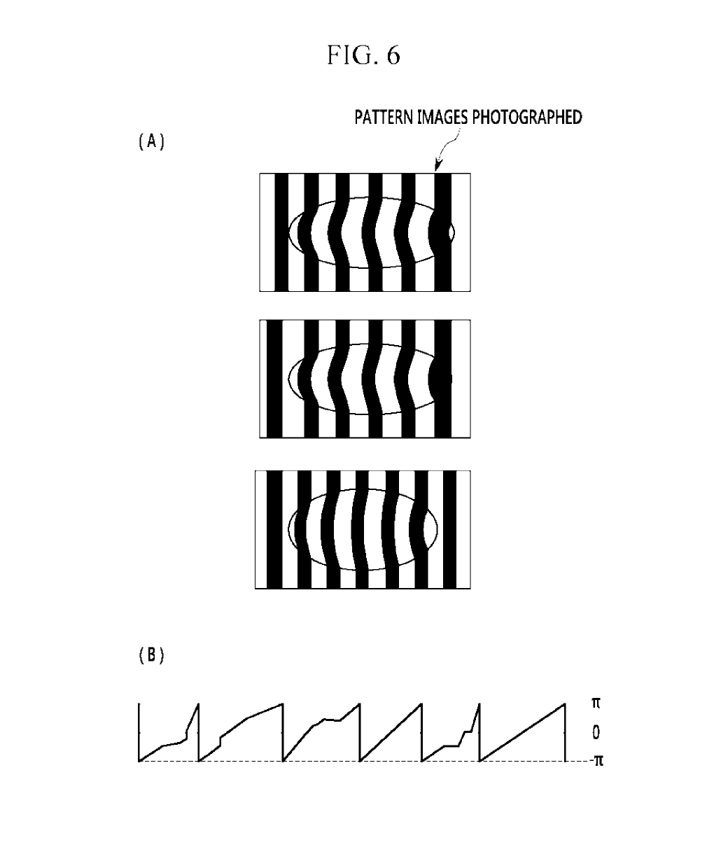

A method for determining a defective portion on a vehicle body in accordance with embodiments of the present disclosure will be described in detail with reference to FIGS. 5 and 6.

FIG. 5 illustrates diagrams showing a pattern image projected onto a vehicle body by a pattern projecting unit 110 and a phase of the pattern image in accordance with embodiments of the present disclosure, respectively. FIG. 6 illustrates diagrams showing a pattern image photographed by a camera unit 150 and a phase of the pattern image in accordance with embodiments of the present disclosure, respectively.

Section (A) of FIG. 5 illustrates a drawing showing a reference pattern image. In particular, the pattern projecting unit 110 projects a plurality of pattern images each shifted by predetermined space to the vehicle body. For convenience of description, although the drawing shows one pattern image, a plurality of pattern images may actually be projected onto the vehicle body which are identical to the pattern image shown in section (A) of FIG. 5, but have predetermined phases shifted by predetermined spaces, respectively.

Section (B) of FIG. 5 is a drawing showing a phase of the pattern image projected thus. The illustrated phases of the pattern image are phases having no defective portion on the vehicle body. Referring to section (B) of FIG. 5, if the vehicle body has no defective portion, it may be known that the phases of the pattern image may have fixed cycles and fixed shapes.

The image control unit 190 has the cycles and the phases of the pattern image previously stored therein as a reference pattern image. Hereinafter, for convenience of description, the cycles and the shapes of the phases of the reference pattern image stored in the image control unit 190 are defined as a reference cycle and a reference shape.

Further, the reference pattern image may be separately stored for each image photographing area of the vehicle body. As an example, if the entire vehicle body is divided into 10 image photographing areas, 10 reference pattern images for respective image photographing areas may be previously stored in the image control unit 190.

Section (A) of FIG. 6 illustrates a drawing showing the pattern images photographed thus. In particular, the camera unit 150 photographs three pattern images projected from the pattern projecting unit 110 having identical shapes but different phases from one another. The drawings show images photographed from the pattern image projected onto oval protrusions, respectively.

Section (B) of FIG. 6 illustrates a drawing showing phases of the pattern images photographed thus. In particular, it may be noticed that cycles and shapes of the phases of the pattern images projected onto the oval protrusions are not the same, but are different.

Therefore, if a reference cycle and a reference shape of the reference pattern image are compared to the cycles and the shapes of the pattern images photographed thus, defective portions, such as protrusions, scratches, recesses, cracks, and so on, may be exactly determined. If a plurality of pattern images having different phases from one another are photographed and compared to the reference pattern image, the defective portions may be determined more accurately.

A method for inspecting a vehicle body in accordance with embodiments of the present disclosure will be now described with reference to the attached drawings.

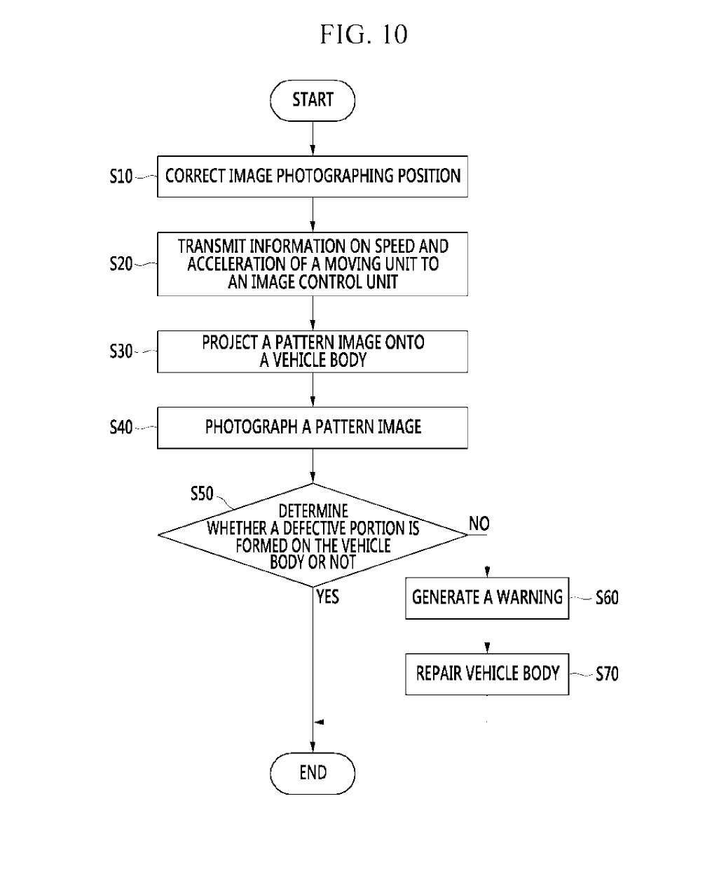

FIG. 10 illustrates a flowchart showing the steps of a method for inspecting a vehicle body in accordance with embodiments of the present disclosure.

As shown in FIG. 10, the image processing unit 100 determines a vehicle body stop position, and the motion control unit 500 corrects an image photographing position according to the vehicle body position (S10).

In detail, the camera unit 150 photographs an image of a reference hole formed in the vehicle body. The image of the reference hole photographed thus is provided to the image control unit 190. The image control unit 190 compares the image of the reference hole photographed thus to a reference pattern image to calculate a correction distance of the vehicle body. The correction distance is provided to the motion control unit 500. Further, the motion control unit 500 controls the moving unit 300 reflecting the correction distance to the control, to set an image photographing area of the vehicle body. That is, by controlling the moving unit 300 having the image processing unit 100 provided thereto according to the correction distance, an image photographing start position and an image photographing end position of the camera unit 150 are set.

In the meantime, at the time the camera unit 150 photographs the pattern image from the vehicle body, the motion control unit 500 transmits information on a speed and acceleration of the moving unit 300 which moves the image processing unit 100 which photographs the images of the vehicle body to the image processing unit 100 (S20). The image processing unit 100 photographs an image of the pattern image projected onto the vehicle body at equal spacing based on the information on the speed and acceleration of the moving unit 300. That is, a speed of image photographing at a constant speed section is made different from a speed of the image photographing at the acceleration or deceleration section for photographing the photograph at equal spacing of the vehicle body. Further, it is preferable that the image photographing areas of the pattern image photographed by the camera unit 150 of the image processing unit 100 are overlapped for predetermined spaces in a length direction and a height direction of the vehicle body.

The pattern projecting unit 110 projects at least one pattern image onto the vehicle body (S30). In this case, it is preferable that the pattern projecting unit 110 projects a plurality of pattern images each having a phase shifted for a predetermined space onto the vehicle body in succession.

The camera unit 150 photographs an image of the pattern image projected onto the vehicle body by the pattern projecting unit 110 (S40). The pattern image photographed by the camera unit 150 is provided to the image control unit 190.

The image control unit 190 compares the pattern image photographed by the camera unit 150 to the reference pattern image, to determine whether the vehicle body has a defective portion or not (S50). As previously described, by comparing the cycle and the shape of the phase on the reference pattern image to the cycle and shape of the phase on the pattern image photographed thus, heights, depths, and shapes of different defective portions formed on the vehicle body are determined.

The image processing unit 100 may compare the pattern image photographed thus to the previously stored reference pattern image, and determine that a defective portion occurs at a portion of the vehicle body where a difference of more than a predetermined range occurs between the pattern image photographed thus and the reference pattern image, and provide an alarm or a warning message to the worker (S60). With the alarm or the warning message, the worker may notice existence of the defective portion on the vehicle body, and perform repair work on the defective portion of the vehicle body (S70).

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: image processing unit
110: pattern projecting unit
111: rotating mirror
112: pattern generating unit
150: camera unit
190: image control unit
300: moving unit
500: motion control unit

What is claimed is:

1. A system for inspecting a vehicle body, comprising:
an image processing unit photographing at least one pattern image projected onto a surface of the vehicle body, comparing the at least one photographed pattern image to a reference pattern image, and determining whether a defective portion is formed on the vehicle body based on the comparison of the at least one photographed pattern image to the reference pattern image;
a moving unit moving the image processing unit in a length direction and a height direction of the vehicle body; and
a motion control unit controlling movement of the moving unit.

2. The system of claim 1, wherein the image processing unit includes:
a pattern projecting unit projecting pattern images, each having a phase shifted by a predetermined space, onto the surface of the vehicle body in succession;
a camera unit photographing the at least one pattern image of the projected pattern images; and
an image control unit comparing the at least one pattern image photographed by the camera unit to the reference pattern image and determining whether the defective portion is formed on the vehicle body based on the comparison of the at least one pattern image photographed by the camera unit to the reference pattern image.

3. The system of claim 2, wherein the pattern projecting unit includes:
a rotating mirror rotatably provided thereto; and
a plurality of pattern generating units arranged at fixed spaces centered on the rotating mirror for generating the pattern images.

4. The system of claim 3, wherein
the pattern images generated by the plurality of pattern generating units have phases shifted by predetermined spaces from one another, and
the pattern images generated by the plurality of pattern generating units are projected onto the vehicle body as the rotating mirror rotates.

5. The system of claim 1, wherein
the motion control unit provides information about a moving speed and acceleration of the moving unit to the image processing unit, and
the image processing unit photographs the pattern images projected onto the surface of the vehicle body at equal spacing based on the information about the moving speed and acceleration.

6. The system of claim 5, wherein image photographing areas of the pattern images photographed by the image processing unit are overlapped by predetermined spaces in the length direction and the height direction of the vehicle body.

7. The system of claim 1, wherein
the image processing unit measures a position of the vehicle body from a reference hole formed in the vehicle body, and
the motion control unit corrects movement of the moving unit according to the position of the vehicle body measured by the image processing unit.

8. The system of claim 7, wherein the image processing unit compares a predetermined reference position to a measured position of the reference hole and calculates a correction distance of the vehicle body based on the comparison of the predetermined reference position to the measured position of the reference hole.

9. A method for inspecting a vehicle body, comprising:
projecting pattern images onto a surface of the vehicle body;
photographing at least one pattern image of the pattern images projected onto the surface of vehicle body;
comparing the at least one photographed pattern image to a reference pattern image; and
determining whether a defective portion is formed on the vehicle body based on the comparison of the at least one photographed pattern image to the reference pattern image.

10. The method of claim 9, wherein the pattern images are projected onto the surface of the vehicle body in succession, each of the pattern images having phases shifted by predetermined spaces.

11. The method of claim 9, wherein the determining of whether the defective portion is formed on the vehicle body comprises:
comparing a phase and a cycle of the at least one photographed pattern image to a phase and a cycle of the reference pattern image.

12. The method of claim 9, further comprising:
correcting an image photographing position based on a position of the vehicle body determined with reference to a vehicle body stop position.

13. The method of claim 12, wherein the correcting of the image photographing position comprises:
photographing a reference hole formed in the vehicle body,
comparing the photographed reference hole to the reference pattern image;
calculating a correction distance of the vehicle body based on the comparison of the photographed reference hole to the reference pattern image, and
setting an image photographing area of the vehicle body according to the calculated correction distance.

14. The method of claim 9, further comprising
transmitting, to an image processing unit which photographs the vehicle body, information about a moving speed and acceleration of a moving unit which moves the image processing unit.

15. The method of claim 14, wherein the pattern images projected onto the vehicle body are photographed at equal spacing based on the information about the moving speed and acceleration.

16. The method of claim 15, wherein image photographing areas of the photographed pattern images are overlapped by predetermined spaces in a length direction and a height direction of the vehicle body.

17. The method of claim 9, further comprising generating a warning when the defective portion is formed on the vehicle body.
